(19) United States
(12) Patent Application Publication
(10) Pub. No.: US 2004/0093334 A1
(43) Pub. Date: May 13, 2004

(54) Profile management system

(76) Inventor: Stephen Scherer, Newport Beach, CA (US)

Correspondence Address: LAW OFFICES OF CLEMENT CHENG, 17220 NEWHOPE STREET #127, FOUNTAIN VALLEY, CA, 92708, US

(21) Appl. No.: 10/292,212

(22) Filed: Nov. 13, 2002

(51) Int. Cl. G06F 7/00

(52) U.S. Cl. 707/8

(57) ABSTRACT

Distributed permission based multi level data access system and method allows personal or business profile information dissemination in discrete, staggered and regulated format across a computer network which may be managed by a central server. Permission based requests and grants are administered by users. Sending users may tag recipient users which both sends a message and increments permission access level.

### BACKGROUND

The Internet has expedited matchmaking in a variety of ways from matching Trubadorean romantic soul mates to finding employment. During the 1990's various Internet matchmaking services were created to harness the vast information exchange potential of the Internet. Meeting and communicating online before meeting in person has become more popular because it allows initial discussion and understanding of a person's personality before meeting the physical person. It also allows a secure online environment that facilitates interaction.

Early matching systems allowed users to meet and interact in real time via text chat. To find other users to chat with, early systems displayed one way searchable personal profiles. A user often has a set of desired criteria or characteristics necessary for a successful match. Thus, personal profiles often included a want list describing the person or situation the user was looking for.

Early systems offered a communication forum via the Internet and profiles to search for compatible matches. Later systems went further to provide two way ranked statistical incidence matches of users' personal profile characteristic data with want data. Unfortunately, this did not assure a user a successful match with others that wanted to meet the user. Some people tend to stretch the truth when they market themselves, and others fabricate blatant lies. More popular users are often inundated with much more correspondence than unpopular users. This continues to make the matching and selection process difficult. Unfortunately, even with the vast information processing power of a global network, these automated systems create their own inefficiencies and suggest inappropriate matches.

In the physical world, persons know each other among a wide variety of categories from strangers to acquaintances to friends. In the virtual world, users typically seek one match. Yet most profiles are shown to the world and anyone such as complete strangers may view private information. Thus, some users withhold certain information. This excludes information from complete strangers that the user does not seek to match with, but also excludes information from the one person that the user desires to match with.

In many kinds of electronic communities, members try to share information with one another. Millions of people have tried such websites with varying degrees of success. Most websites offering communication services follow some basic and common elements. The largest and most successful to date, Match.com, is a good example. User members are asked to provide personal information about themselves and fill out lengthy profile forms, all to help in meeting new friends. Other members can then view the data, and determine with whom they choose to communicate.

The system does not allow people to release their profile information piecemeal or in context to their relationship. Ideally, users of online databases should be able to choose what type and how much information they wish to give others. In the current state of the art, members create profiles that all other registered users can access. There are currently no methods available to aid users in controlling the release of their private information. If users want to disclose information to select other users that they consider too sensitive and private for the general population of users, they must resort to manual processes such as individual emails.

### BRIEF DESCRIPTION OF THE DRAWINGS

FIG. 1 is a flow diagram of an example of the system process.

### OBJECT OF THE INVENTION

To provide an effective mechanism on current electronic community sites to allow users to control the dissemination of private information in a uniform, convenient, and secure way. To allow users more control over private information by offering dissemination based on permission-based stages and contextual profiles. The purpose of the invention is to provide a technical mechanism for members of an electronic community to share private information with one another conveniently and securely. The invention offers users inside the community a specific method of control concerning the dissemination of this personal information.

### BRIEF SUMMARY OF THE INVENTION

Distributed permission based multi level data access system and method allows personal or business profile information dissemination in discrete, staggered and regulated format across a computer network which may be managed by a central server. Users administer permission based requests and grants. Sending users may tag recipient users which both sends a message and increments permission access level.

### DETAILED DESCRIPTION OF THE PREFERRED EMBODIMENT

The present invention comprises a system hosted on a server computer connected to terminal computers via a network. The network connects various users that seek matches with other users. The computer network includes user profiles stored on a database. The user profiles are hierarchically arranged in increasing order of specificity, sensitivity, and privacy. Lower level profiles are numbered beginning at level 1, which is the most cursory and general profile that would be shown to strangers.

Users are people with membership to a searchable database and enabled email. Users can search through the profiles of other users, using an application installed on the network. The network also allows users to correspond and communicate via e-mail and text messages.

The advancement of a user from one level to another for a particular profile constitutes and is termed as a ‘tag’. The ‘tag’ system and method allows users to grant access permission in a convenient and secure way. When a user ‘tags’ a second user, the first user grants the second user access to the information in the next and higher profile level. The second user receives a message indicating the new access clearance.

The ‘tag’ system facilitates control over the dissemination of personal and potentially confidential information. Users selectively grant access to their private information through use of this mechanism. By ‘taggin’ someone, users call attention to their profile information and grant access to their own data. The system invention allows users to enter their private and potentially sensitive information in several different profile levels. Users can grant others access to different levels via their terminal that sends requests and access permission to the central server software. The system website will allow users to control and manage their data by allowing them to store the data in progressively more secure levels. Level one is the ‘public’ level, visible by all users. Level two is the next level, and is only accessible through permission granted by the user.

Access to information in other, higher levels beyond the first level (such as levels two and three) requires explicit permission. Once users set up information in these profile levels, they can quickly grant access to certain members while withholding access to others.

Users have an administrative control area within the website software that displays the current status of access that they have granted others, as well as received from others. The data can be displayed in list or tabular format. The level of clearance granted other users can be changed at any time.

A level 1 profile for a user seeking a romantic relationship on a personal matchmaking service may include a variety of general superficial characteristics such as gender, age, geographical location, occupation, race, religion, activities and personal hobbies. A level 2 profile for a dating service user may include more specific and fundamental information such as personal beliefs and life goals that a user would show to acquaintances. The same user may have more private information such as a personal photo included at a level 3 profile.

The same system can be applied to regulate employment and recruitment over the Internet. A profile can include job qualifications in the case of an employer or recruiter profile. A level 1 recruiter profile may list job qualifications such as education, geographical location and general experience. A level 2 recruiter profile may further include information such as salaries and benefits. A level 3 profile could further include internal company policies and regulations.

A job seeker may post a level 1 profile having a resume and contact information. A level 2 profile for a job seeker may contain information such as references and college transcripts. Finally, a level 3 profile for a job seeker may contain salary requirements and salary history.

A user may author various profile levels customized for his or her particular needs. The designation of various information at different levels is also useful information to other users. A user searching through a personals database for a prospective mate may define the profile levels as he or she desires.

### EXAMPLE

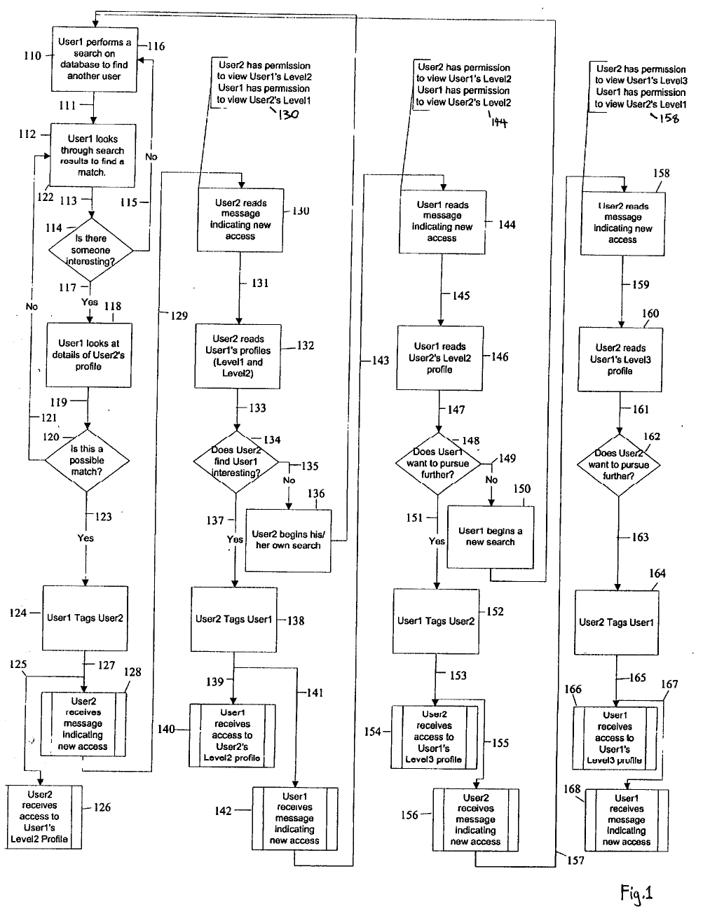

Users create personal profiles having various levels. Profile information may be in any multimedia format such as text, graphics, a video clip or a sound clip. Users restrict access to their personal profile information by selectively granting certain levels of access. In FIG. 1, the first user, referred to for now on as “User 1,” searches the database, which contains limited information about other users, in order to find another user he or she may be interested in (110). User 1 completes a search (111) and then browses database search results to find a possible match (112). After browsing the results (113), User 1 decides if there is a choice he or she considers interesting (114). If user 1 decides in the negative (115), then User 1 conducts a new search (116). If User 1 responds affirmatively and finds an interesting choice (117), however, then he or she proceeds to browse the details of user 2's level one profile (118).

After finishing his or her browsing of user 2's level one profile (119), user 1 decides if user 2 is a possible match (120). If user 1 responds negatively (121) then user 1 will return to the database results to see if there are other possible matches (122). If user 1 responds affirmatively (123), however, then user 1 may ‘tag’ user 2 (124). This results in user 1 sending user 2 access to his or her level 2 profile (125) and user 2 receiving access to userl's level 2 profile (126). A new access notification is sent to user 2 by user 1 (127) and user 2 receives this message indicating new access (128). After acknowledging this new access notification (129) user 2 reads the message indicating new access (130) and then acknowledges this new access (131) which leads in turn to user 2's reading of user 1's level 2 profile (132).

After finishing browsing user 1's level 2 profile (133) user 2 may determine whether or not he or she finds user 1 interesting (134). If user 2 answers negatively (135) then he or she begins their own new search (136). If user 2 answers affirmatively (137), however, user 2 will tag user 1 (138). This results in user 2 sending user 1 access to his or her level 2 profile (139) and user 1 of course then receiving access to user 2's level 2 profile (140). A new access notification is sent to user 1 by user 2 (141) and of course, as a result, user 1 receives a message indicating new access (142). After acknowledging this new access notification (143), user 1 reads the message indicating new access (144). User 1 then acknowledges this new access (145) and proceeds to examine user 2's level 2 profile (146).

After finishing browsing user 2's level 2 profile (147), user 1 decides whether or not to pursue the relationship further (148). If User 1 decides negatively (149) then User 1 can then begin a new search (150). If user1 decides affirmatively (151) however, then user1 will once again tag user 2 (152). User 1 will now send user 2 access to his or her level 3 profile (153) and user 2 will, as a result, receive access to user1's level 3 profile (154). User 1 also sends a message to user 2 indicating new access (155) and user 2 receives this message indicating new access (156). User 2 then acknowledges this new access message (157) and reads the message indicating new access (158). User 2 decides to access User 1's level three profile (159) and then reads user 1's level three profile (160).

After completion of browsing user 1's level three profile, (161) user 2 decides whether or not to continue (162). If user 2 answers “yes” (163) then user 2 will then tag user 1 (164) and send access to his her level three profile (165). As a result, user 1 will then receive access to User 2's level three profile (166). User 2 will send user 1 a message indicating new access (167) and user 1 will receive a message indicating new access (168).

Although, the number of access levels may be numerous and encompass a wide variety of possible relationships, the process of granting permissions by tagging remains the same.

By granting tags, the process of information dissemination may be regulated by the user. The tag process may be regulated by the system also. For example, a third level tag is a tag that grants third level access. The system may require sequential tag ordering which would require that a second level tag be sent to a recipient user before a third level tag may be sent. Sequential tag ordering would also require that a lower-level tag be sent before a higher-level tag.

Tag gap may also be regulated by the system. A tag gap is the difference between a sent tag level and the tag recipient's access level to the tag sender's access level. The system may allow users to automatically reject tag messages by setting a tag gap parameter that allows a user to customize the tag gap. Preferably, the system may impose system wide minimum tag gap. This example of user and systemwide regulation of tags shows how the tag system allows an efficient, safe and ordered networked society.

The foregoing describes the preferred embodiments of the invention and modifications may be made without departing from the spirit and scope of the invention as set forth in the following claims.

1. A method for configuring a computer network to allow users in a networked community to selectively grant profile information comprising the steps of:
a. configuring a server to allow users to post profile information in a profile database,
b. configuring a server to allow users to assign access levels to particular profile information, the profile information having access levels of increasing sensitivity,
c. configuring a server to grant all users access to a first level profile, granting user's access to other user's subsequent profiles if permission has been granted,
d. configuring a server to provide email to users, so users may send messages to one another,
e. configuring a server to allow a tag sending user to tag a tag recipient user, wherein a tag sent by a tag sending user increases the tag recipient user's access level to the sending user's profile, the tag accompanied by a message to the tag recipient user, whereby the tag recipient user has access to more profile information regarding the tag sending user.

2. The method of claim 1 further comprising the step of: configuring a computer network to implement sequential tag ordering, whereby lower-level tags must be sent before higher-level tags.

3. The method of claim 1 further comprising the step of: configuring a computer network to automatically reject tag messages when they exceed a tag gap parameter set by a user.

4. The method of claim 1 further comprising the step of: configuring a computer network to automatically reject tag messages when they exceed a tag gap parameter imposed system wide by a system administrator.

5. A method for configuring a computer network to allow users in a networked matchmaking community to selectively grant personal profile information comprised of a set of personal information comprising the steps of:
a. allowing users to post personal profile information in a personal profile database,
b. allowing users to assign access levels to increasingly private profile information, the profile information segmented into various access levels,
c. granting user's access to other user's first level profile, a first level profile containing electronic contact information for the respective user, granting user's access to other user's subsequent profiles if permission has been granted,
d. providing an email box and address to users, whereby users may send messages to one another,
e. allowing a tag sending user to tag a tag recipient user, wherein a tag sent by a tag sending user increments the tag recipient user's access level when accessing the sending user's profile, whereby the tag recipient user may access more of the tag sending user's personal information.

6. The method of claim 5 wherein the computer network and a server are implemented on the Internet.

7. The method of claim 5 wherein the computer network and a server are implemented on an Intranet.

8. The method of claim 5 wherein the computer network is implemented on an Intranet and the Internet.

9. A computer network to allow users in a networked matchmaking community to selectively grant personal profile information comprised of a set of personal information comprising:
a. a database storing personal profiles of users who are allowed to post personal profile information in a personal profile,
b. a server accessing said database and communicating with terminals to allow users to assign access levels to increasingly private profile information, the profile information segmented into various access levels, the server granting user's access to other user's first level profile, a first level profile containing electronic contact information for the respective user, granting user's access to other user's subsequent profiles if permission has been granted, the server providing an email box and address to users, whereby users may send messages to one another, the server allowing a tag sending user to tag a tag recipient user, wherein a tag sent by a tag sending user increments the tag recipient user's access level when accessing the sending user's profile, whereby the tag recipient user may access more of the tag sending user's personal information.

10. The method of claim 9 wherein the computer network and server are implemented on the Internet.

11. The method of claim 9 wherein the computer network and server are implemented on an Intranet.

12. The method of claim 9 wherein the computer network and server are implemented on an Intranet and the Internet.

13. The method of claim 9 wherein the server implements sequential tag ordering, whereby lower-level tags must be sent before higher-level tags.

14. The method of claim 9 wherein the server automatically rejects tag messages when they exceed a tag gap parameter set by a user.

15. The method of claim 9 wherein the server automatically reject tag messages when they exceed a tag gap parameter imposed system wide by a system administrator.
